(19) United States
(12) Patent Application Publication
(10) Pub. No.: US 2025/0073752 A1
(43) Pub. Date: Mar. 6, 2025

(54) THIN FILM DEFORMATION ELEMENT AND MULTI-TACTILE FEEDBACK COMPONENT

(71) Applicant: Industrial Technology Research Institute, Hsinchu (TW)

(72) Inventors: Chen-Tsai Yang, Taoyuan City (TW); Chih-Cheng Cheng, Taichung City (TW); Wan-Hsin Chen, Hsinchu City (TW); Chien-Hsun Chu, Hsinchu County (TW); Li-Wei Yao, Kaohsiung City (TW)

(73) Assignee: Industrial Technology Research Institute, Hsinchu (TW)

(21) Appl. No.: 18/818,608

(22) Filed: Aug. 29, 2024

Related U.S. Application Data
(60) Provisional application No. 63/535,073, filed on Aug. 29, 2023.

(51) Int. Cl. B06B 1/06; G08B 6/00

(52) U.S. Cl. CPC B06B 1/0688; G08B 6/00

(57) ABSTRACT

A multi-tactile feedback component is suitable for an electronic device and includes a thin film deformation element, a thin film vibration element, and a power module. The thin film deformation element has first and second elastic layers and a gain layer disposed therebetween and forming a channel to accommodate a fluid. The thin film vibration element is connected to the thin film deformation element and has a piezoelectric layer and tactile structures. The tactile structures are disposed at a side surface of the piezoelectric layer. The power module is coupled to the thin film deformation element and the thin film vibration element. When the power module supplies an electrical energy to the thin film deformation element, the first elastic layer is deformed to push the fluid and the second elastic layer. When the power module supplies the electrical energy to the thin film vibration element, the piezoelectric layer vibrates.

### CROSS-REFERENCE TO RELATED APPLICATION

This application claims the priority benefit of U.S. provisional application Ser. No. 63/535,073, filed on Aug. 29, 2023. The entirety of the above-mentioned patent application is hereby incorporated by reference herein and made a part of this specification.

### TECHNICAL FIELD

The disclosure relates to a feedback component, and also to a multi-tactile feedback component simulating different tactile sensations.

### BACKGROUND

In recent years, digital techniques such as VR and AR have provided sensory experiences that simulate reality or combine reality. Common devices include VR glasses, head-mounted displays, or 3D displays, and may be used in the entertainment industry, training and education, and online virtual meetings.

VR systems include visual feedback, auditory feedback, and tactile feedback. VR systems generate realistic images, and speakers output sound, and then vibration or deformation is generated via tactile devices mounted on the limbs to simulate force feedback.

In particular, auditory feedback and visual feedback are relatively mature, but tactile feedback still has development bottlenecks. Most of the existing tactile feedback devices are exoskeletons or pneumatic. Such devices have the disadvantages of being large and bulky. Therefore, users are likely to feel uncomfortable when worn for a long time. In addition, existing tactile feedback devices only have a single feedback function. Therefore, how to achieve the objects of lightweight and a variety of combinations of feedback experiences is a key breakthrough point of existing tactile feedback devices.

### SUMMARY

An embodiment of the disclosure provides a multi-tactile feedback component combining a thin film deformation element and a thin film vibration element to enhance the fidelity of the multi-tactile feedback component.

A multi-tactile feedback component of an embodiment of the disclosure is suitable for an electronic device. The multi-tactile feedback component includes a thin film deformation element, a thin film vibration element, and a power module. The thin film deformation element has a first elastic layer, a second elastic layer, and a gain layer. The gain layer is disposed between the first elastic layer and the second elastic layer and forms a channel to accommodate a fluid. The thin film vibration element is connected to the thin film deformation element and has a piezoelectric layer and a plurality of tactile structures. The plurality of tactile structures are disposed at a side surface of the piezoelectric layer. The power module is coupled to the thin film deformation element and the thin film vibration element. When the power module supplies an electrical energy to the thin film deformation element, the first elastic layer is deformed to push the fluid and the second elastic layer. When the power module supplies the electrical energy to the thin film vibration element, the piezoelectric layer vibrates.

### BRIEF DESCRIPTION OF THE DRAWINGS

FIG. 1A is a schematic structural diagram of a multi-tactile feedback component of an embodiment of the disclosure.

FIG. 1B is a schematic diagram of the operation of the multi-tactile feedback component of FIG. 1A.

FIG. 2A is a schematic structural diagram of a multi-tactile feedback component of another embodiment of the disclosure.

FIG. 2B is a schematic diagram of the operation of the multi-tactile feedback component of FIG. 2A.

FIG. 3A is a schematic structural diagram of a multi-tactile feedback component of another embodiment of the disclosure.

FIG. 3B is a schematic diagram of the operation of the multi-tactile feedback component of FIG. 3A.

FIG. 4A to FIG. 4C are three-dimensional schematic diagrams of adopting different support layers according to an embodiment of the disclosure.

FIG. 5A to FIG. 5D are three-dimensional schematic diagrams of tactile structures adopting different shapes according to an embodiment of the disclosure.

FIG. 6A to FIG. 6D are three-dimensional schematic diagrams of perforations and top openings adopting different shapes and quantities according to an embodiment of the disclosure.

FIG. 7A and FIG. 7B are schematic three-dimensional diagrams of channels adopting different shapes according to an embodiment of the disclosure.

FIG. 8A is a schematic structural diagram combining an external power supply according to an embodiment of the disclosure.

FIG. 8B is a schematic structural diagram of the common electrode of the external power supply and the power module of FIG. 8A.

FIG. 9 is a schematic structural diagram of combining a sensing module and a control module according to an embodiment of the disclosure.

FIG. 10 is a schematic structural diagram of a multi-tactile feedback component of another embodiment of the disclosure.

### DETAILED DESCRIPTION OF DISCLOSED EMBODIMENTS

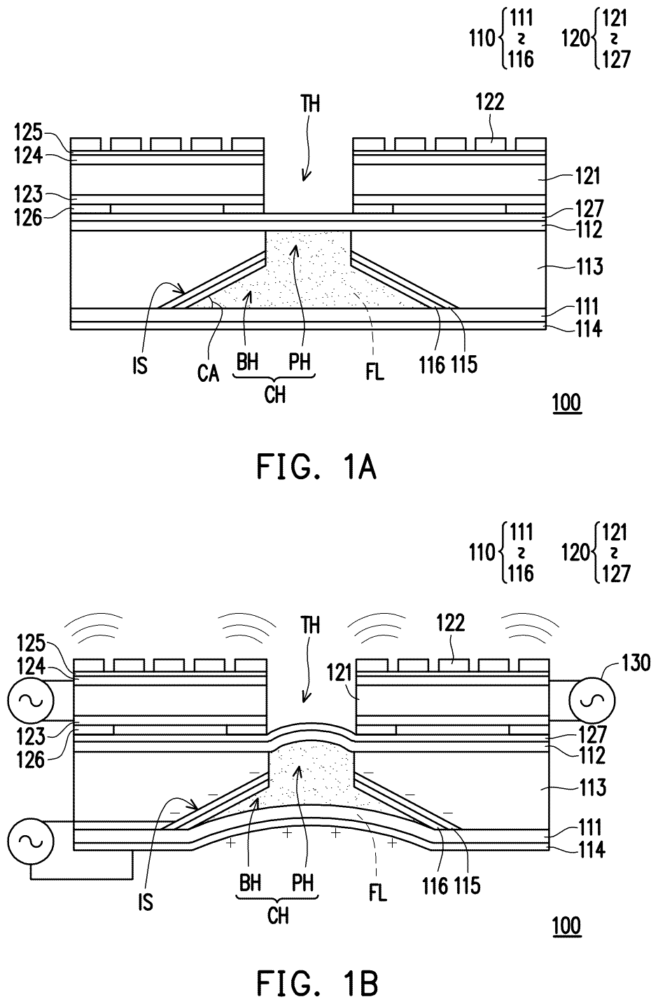

FIG. 1A is a schematic structural diagram of a multi-tactile feedback component of an embodiment of the disclosure. FIG. 1B is a schematic diagram of the operation of the multi-tactile feedback component of FIG. 1A.

Referring to FIG. 1A, a multi-tactile feedback component 100 of an embodiment of the disclosure is suitable for an electronic device. The multi-tactile feedback component 100 includes a thin film deformation element 110, a thin film vibration element 120, and a power module 130. The thin film deformation element 110 has a first elastic layer 111, a second elastic layer 112, and a gain layer 113. The gain layer 113 is disposed between the first elastic layer 111 and the second elastic layer 112 and forms a channel CH to accommodate a fluid FL. In particular, the elastic layers 111 and 112 adopt thermoplastic polyurethane (TPU), polyurethane (PU), or polydimethylsiloxane (PDMS), for example. The fluid FL adopts air, water, silicone oil, or tar, for example. The gain layer 113 adopts photocurable resin, polydimethylsiloxane (PDMS), polyimide (PI), polyethylene terephthalate (PET), or polyvinyl chloride (PVC).

The thin film vibration element 120 is connected to the thin film deformation element 110 and has a piezoelectric layer 121 and a plurality of tactile structures 122. One side surface of the piezoelectric layer 121 is connected to the second elastic layer 112 disposed at the thin film deformation element 110, and the plurality of tactile structures 122 are disposed at another side surface of the piezoelectric layer 121. The power module 130 is coupled to the thin film deformation element 110 and the thin film vibration element 120 and used to provide electrical energy to drive the operation of the thin film deformation element 110 and the thin film vibration element 120.

Referring to FIG. 1B, when the power module 130 supplies electrical energy to the thin film deformation element 110, the first elastic layer 111 is deformed due to electrostatic force to push the fluid FL and the second elastic layer 112, and when the fluid FL passes through the channel CH of the gain layer 113, the external force applied to the second elastic layer 112 is amplified to increase the displacement amount of the second elastic layer 112. When the power module 130 supplies electrical energy to the thin film vibration element 120, the piezoelectric layer 121 generates periodic vibration. In addition, the amplitude and the vibration frequency depend on the structural strength of the piezoelectric layer 121 and may also be changed according to the amount of input electrical energy.

In addition, the tactile structure 122 is suitable for contacting the fingers of the user to provide grainy and frictional feedback.

Referring to FIG. 1A and FIG. 1B, the thin film deformation element 110 has a first metal layer 114, a second metal layer 115, and an insulating layer 116. The first metal layer 114 is disposed at the first elastic layer 111 and away from the gain layer 113, the second metal layer 115 is disposed at an inner wall surface IS of the gain layer 113 facing the first elastic layer 111, and the insulating layer 116 covers the second metal layer 115. In addition, the metal layer includes, for example, copper (Cu), titanium (Ti), molybdenum (Mo), gold (Au), silver (Ag), Al (aluminum), or one of similar metals or an alloy thereof.

In particular, the channel CH has a bottom opening BH and a top opening PH, a width WD of the bottom opening BH is gradually decreased from the first elastic layer 111 toward the second elastic layer 112 to form a funnel-shaped appearance, the top opening PH is connected to the bottom opening BH and partially exposes the second elastic layer 112, and the width of the top opening PH is fixed and constant. The ratio of the area of the top opening PH to the area of the bottom opening BH is less than or equal to one, indicating the bottom opening BH is greater than or equal to the top opening PH.

Referring to FIG. 1B, after the thin film deformation element 110 receives electrical energy from the power module 130, the first metal layer 114 generates positive charge, the second metal layer 115 generates negative charge, and the second metal layer 115 electrically attracts the first metal layer 114 via electrostatic force, so that the first elastic layer 111 is deformed to be close to the insulating layer 116 and compress the channel CH, and the first elastic layer 111 pushes the fluid FL to flow toward and squeeze the second elastic layer 112. Via the combination of the bottom opening BH and the top opening PH, when the fluid FL flows from the bottom opening BH toward the top opening PH, due to the tapered cross-sectional area of the channel CH, the flow rate of the fluid FL is amplified, and the external force exerted by the fluid FL on the second elastic layer 112 is increased, thereby increasing the deformation amount of the second elastic layer 112.

Referring to FIG. 1A, there is an inclination angle CA (non-horizontal configuration) between the first metal layer 114 and the second metal layer 115, and the inclination angle CA ranges from 2 degrees to 10 degrees. When the inclination angle CA is smaller, the driving voltage is smaller. In addition, the inclination angle CA may help start the first elastic layer 111 to generate deformation.

In short, the thin film deformation element 110 is deformed via electrostatic force, and the output displacement amount is increased via the channel CH of the gain layer 113.

Referring to FIG. 1A and FIG. 1B, the thin film vibration element 120 has a third metal layer 123, a fourth metal layer 124, a barrier layer 125, and a support layer 126. The third metal layer 123 and the fourth metal layer 124 are respectively disposed at two opposite sides of the piezoelectric layer 121. The barrier layer 125 covers the fourth metal layer 124. The plurality of tactile structures 122 are distributed in an array at the barrier layer 125. The support layer 126 is disposed at the third metal layer 123, and the support layer 126 is connected to the second elastic layer 112 of the thin film deformation element 110 via an adhesive layer 127. In addition, the material of the piezoelectric layer 121 adopts, for example, polyvinylidene fluoride (PVDF), lead zirconate titanate (PZT), lead niobate titanate (PMN-PT), zinc oxide (ZnO), or aluminum nitride (AlN), and the material of the tactile structures 122 adopts, for example, copper (Cu), aluminum (Al), iron (Fe), gold (Au), silver (Ag), molybdenum (Mo), titanium (Ti), or polydimethylsiloxane (PDMS).

Furthermore, the thin film vibration element 120 has a perforation TH formed at the center of the thin film vibration element 120 and penetrating the piezoelectric layer 121, the third metal layer 123, the fourth metal layer 124, and the barrier layer 125, and the plurality of tactile structures 122 surround the perforation TH on the outside, and the second elastic layer 112 partially enters the perforation TH after being deformed (see FIG. 1B).

Furthermore, the tactile structures 122 may adopt a high-hardness material to overcome the vibration degradation loss caused by a soft material, or may adopt a staggered arrangement of soft and hard materials to increase the variety of tactile sensations.

Furthermore, the support layer 126 is used to increase the swing amplitude of the piezoelectric layer 121 and adjust the vibration frequency of the piezoelectric layer 121, thereby improving the vibration sensitivity of the thin film vibration element 120. The plurality of tactile structures 122 are used to transmit the vibration of the piezoelectric layer 121 to the fingers of the user. The support layer 126 is combined with the third metal layer 123 to allow the third metal layer 123 to act as a weight metal and generate structural resonance. The combination of the support layer 126 and the third metal layer 123 may increase the amplitude of the piezoelectric layer 121, and the vibration frequency of the piezoelectric layer 121 is further adjusted to be within 500 Hz to improve the vibration sensitivity of the thin film vibration element 120. In addition, the support layer 126 may allow the thin film vibration element 120 to form different vibration structures according to different connection forms, such as: cantilever beam structure, simply supported beam structure, etc., and is not limited to the above.

In addition, the support layer 126 has a thickness of about 1 μm to 30 μm and the material thereof adopts, for example, acrylic, rubber, epoxy resin, acrylic, or adhesive, and the support layer 126 forms a space to accommodate the deformation amount of the thin film vibration element 120 during vibration or swinging, and the deformation space is hollow or filled with a soft material (such as PDMS).

In short, in the multi-tactile feedback component 100 of the present embodiment, after the power module 130 is activated, the thin film deformation element 110 generates static electricity to generate deformation. At the same time, the thin film vibration element 120 generates periodic vibration, allowing the fingers in contact with the tactile structure 122 to experience compound tactile feedback.

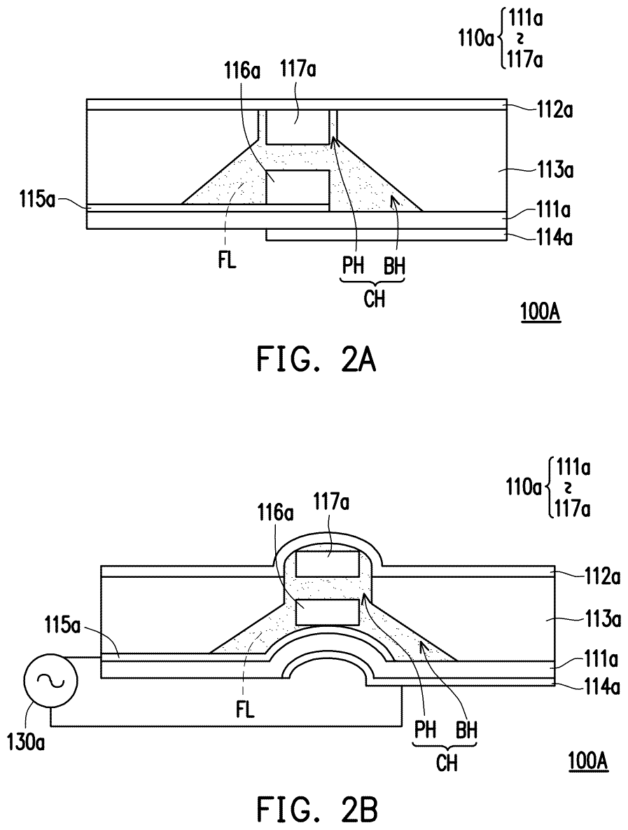

FIG. 2A is a schematic structural diagram of a multi-tactile feedback component of another embodiment of the disclosure. FIG. 2B is a schematic diagram of the operation of the multi-tactile feedback component of FIG. 2A.

Referring to FIG. 2A, a multi-tactile feedback component 100A of the present embodiment is different from the multi-tactile feedback component 100 of FIG. 1A. The difference is that a thin film deformation element 110a has a first metal layer 114a, a second metal layer 115a, a first magnetic block 116a, and a second magnetic block 117a. The first metal layer 114a is disposed at a first elastic layer 111a and away from a gain layer 113a, the second metal layer 115a is disposed between the gain layer 113a and the first elastic layer 111a, and the first metal layer 114a and the second metal layer 115a are partially overlapped, the first magnetic block 116a is disposed at the second metal layer 115a, and the second magnetic block 117a is disposed at a second elastic layer 112a and aligned with the first magnetic block 116a.

In particular, the first magnetic block 116a is located at the bottom opening BH of the channel CH, and the second magnetic block 117a is located at the top opening PH of the channel CH.

With reference to FIG. 2B, after the thin film deformation element 110a receives the electrical energy from a power module 130a, the first metal layer 114a generates positive charge, the second metal layer 115a generates negative charge, and the second metal layer 115a electrically attracts the first metal layer 114a via electrostatic force, such that the first elastic layer 111a is deformed to compress the channel CH and drive the fluid FL to flow toward the second elastic layer 112a. At the same time, the first elastic layer 111a drives the first magnetic block 116a close to the second magnetic block 117a, and the first magnetic block 116a and the second magnetic block 117a magnetically repel each other to squeeze the second elastic layer 112a.

Furthermore, when the fluid FL flows from the bottom opening BH toward the top opening PH, due to the tapered cross-sectional area of the channel CH, the displacement of the fluid FL is amplified, and the external force exerted by the fluid FL on the second elastic layer 112a is increased, thereby increasing the deformation amount of the second elastic layer 112. In addition, the magnetic repulsion between the first magnetic block 116a and the second magnetic block 117a also increases the deformation amount of the second elastic layer 112a.

In short, in the multi-tactile feedback component 100A of the present embodiment, after the power module 130a is activated, the thin film deformation element 110a forms static electricity and generates deformation with magnetic force. At the same time, the thin film vibration element 120a generates periodic vibration, allowing the fingers in contact with the tactile structure 122a to experience compound tactile feedback.

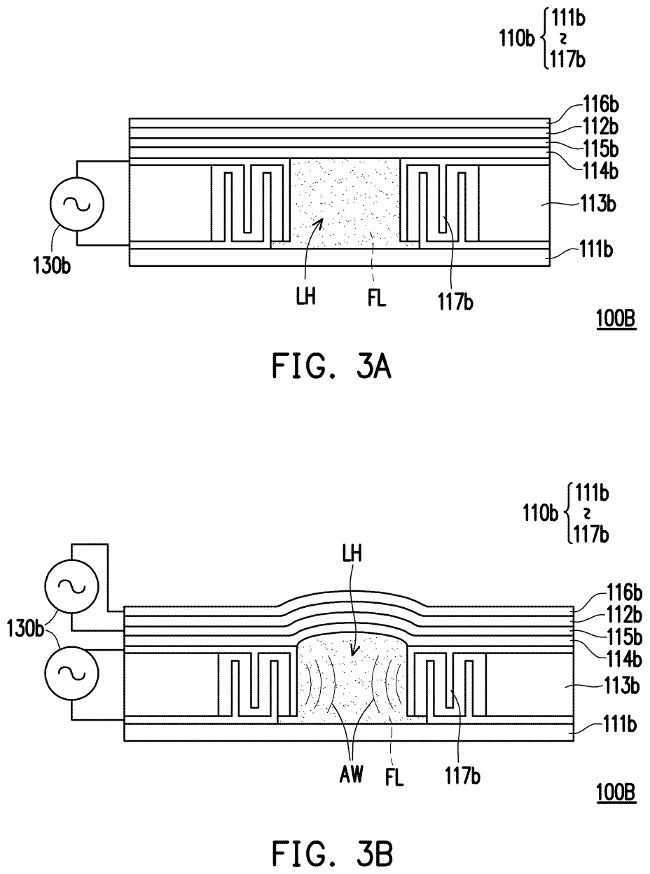

FIG. 3A is a schematic structural diagram of a multi-tactile feedback component of another embodiment of the disclosure. FIG. 3B is a schematic diagram of the operation of the multi-tactile feedback component of FIG. 3A.

Referring to FIG. 3A, a multi-tactile feedback component 100B of the present embodiment is different from the multi-tactile feedback component 100 of FIG. 1A. The difference is that a thin film deformation element 110b has an insulating layer 114b, a first metal layer 115b, a second metal layer 116b, and two-finger interdigitated electrodes 117b. The insulating layer 114b is disposed at a side of a gain layer 113b relative to a first elastic layer 111b. The first metal layer 115b and the second metal layer 116b are respectively disposed at two opposite sides of a second elastic layer 112b. The first metal layer 115b is in contact with the insulating layer 114b. The two-finger interdigitated electrodes 117b are located in the channel CH and spaced apart from each other. The two-finger interdigitated electrodes 117b are disposed at the inner side surface of the gain layer 113b.

Referring to FIG. 3B, after the thin film deformation element 110b receives the electrical energy from a power module 130b, the power module 130b also supplies power to the first metal layer 115b and the second metal layer 116b, such that the first metal layer 115b generates positive charge, the second metal layer 116b generates negative charge, and the second metal layer 116b electrically attracts the first metal layer 115b via electrostatic force, such that the second elastic layer 112b is deformed. At the same time, the two-finger interdigitated electrodes 117b generate an ultrasonic wave AW and resonate in the channel CH to push the fluid FL so as to squeeze the second elastic layer 112b.

In short, in the multi-tactile feedback component 100B of the present embodiment, after the power module 130b is activated, the thin film deformation element 110b forms static electricity and generates deformation with piezoelectric ultrasound. At the same time, the thin film vibration element generates periodic vibration, allowing the fingers in contact with the tactile structure to experience compound tactile feedback.

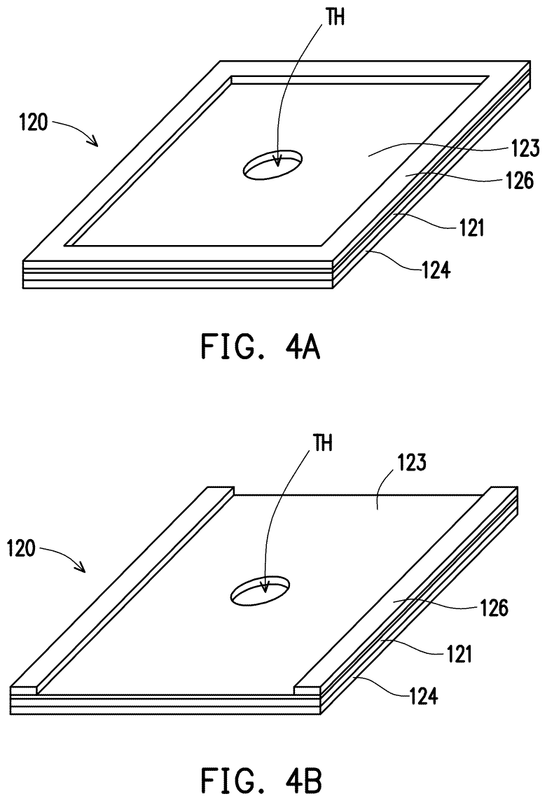

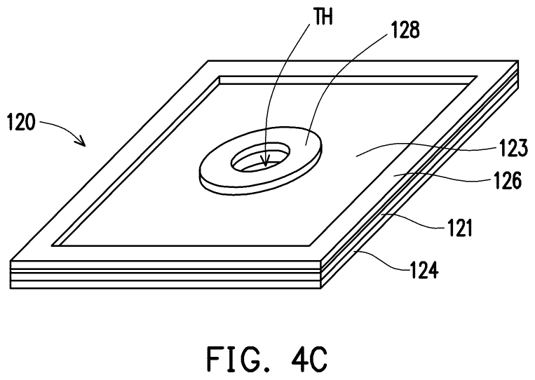

FIG. 4A to FIG. 4C are three-dimensional schematic diagrams of the multi-tactile feedback component of FIG. 1A adopting different support layers.

Referring to FIG. 1A and FIG. 4A, the support layer 126 of the present embodiment is disposed around the edge of the third metal layer 123, thereby evenly distributing the support force at the edge of the third metal layer 123.

Referring to FIG. 4B, the support layer 126 of the present embodiment is disposed at two opposite edges of the third metal layer 123, thus simplifying the manufacturing process.

Referring to FIG. 4C, the multi-tactile feedback component of the present embodiment also includes an auxiliary layer 128 disposed at the center of the third metal layer 123 and surrounding the perforation TH of the thin film vibration element 120. The support layer 126 is disposed around the edge of the third metal layer 123, thereby evenly distributing the support force at the edge and the center of the third metal layer 123. Furthermore, the area ratio of the support layer 126 and the third metal layer 123 may be adjusted, thereby modulating the vibration frequency of the thin film vibration element 120. For example, if the area ratio of the support layer 126 and the third metal layer 123 is small, the thin film vibration element 120 provides a low-frequency vibration frequency. If the area ratio of the support layer 126 and the third metal layer 123 is large, the thin film vibration element 120 provides a high-frequency vibration frequency.

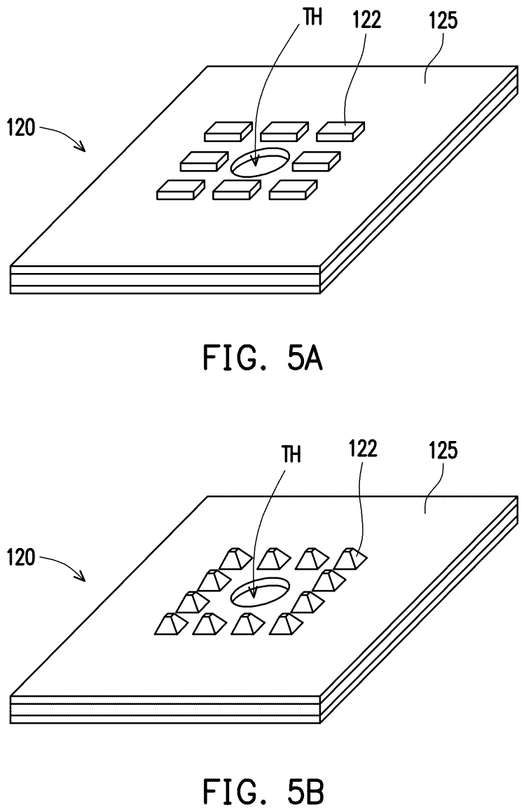

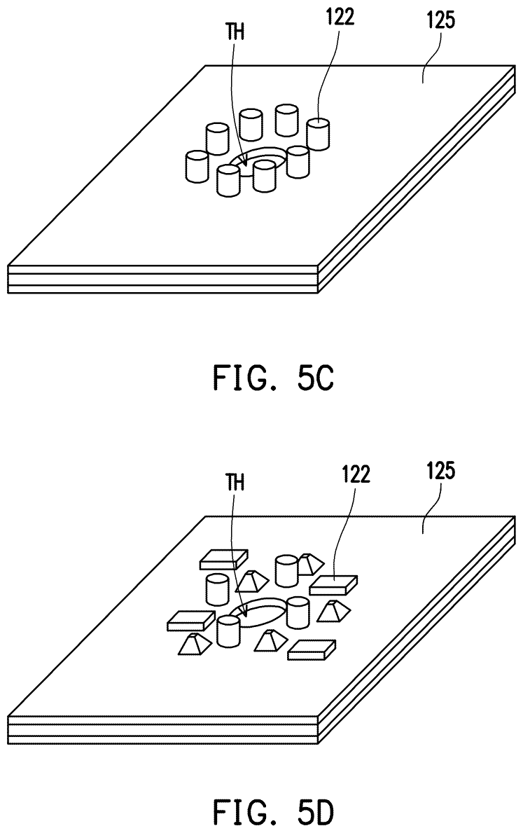

FIG. 5A to FIG. 5D are three-dimensional schematic diagrams of the multi-tactile feedback component of FIG. 1A adopting tactile structures of different shapes.

Referring to FIG. 5A to FIG. 5D, the plurality of tactile structures 122 of the present embodiment adopts square pillars (FIG. 5A), tower shapes (FIG. 5B), cylinders (FIG. 5C), or a combination of the above (FIG. 5D), and the plurality of tactile structures 122 surround the periphery of the perforation TH and are distributed in an array.

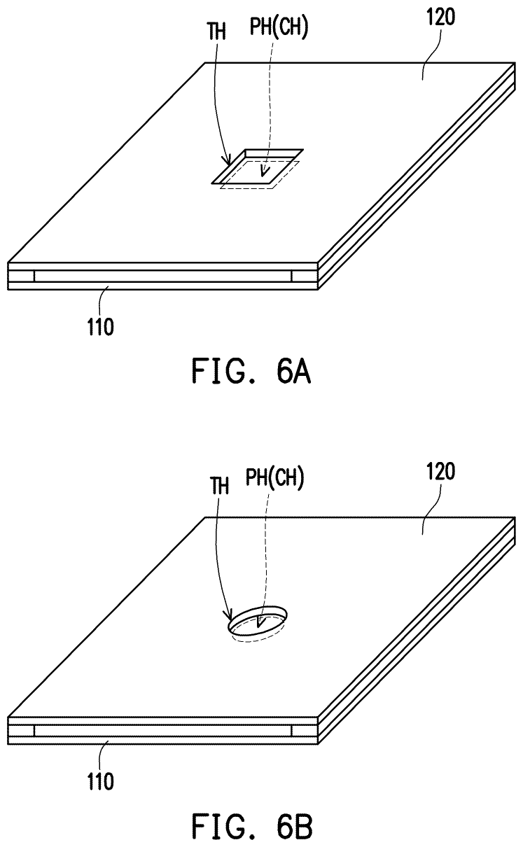

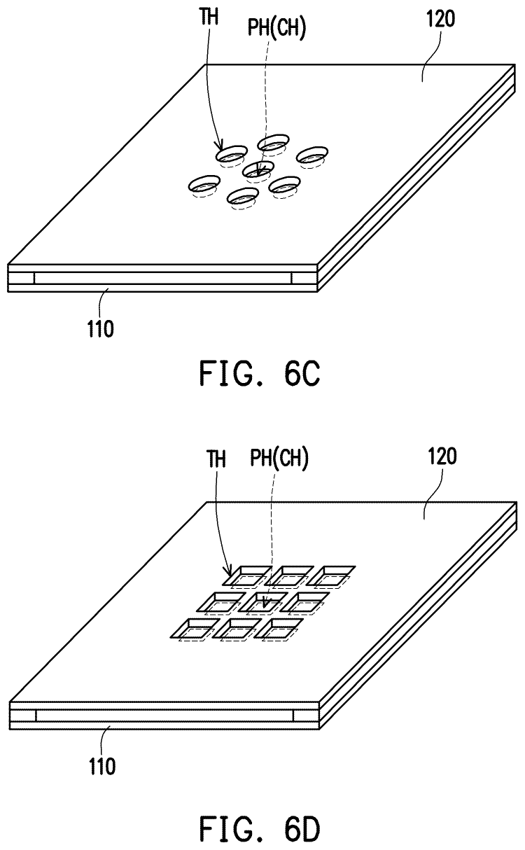

FIG. 6A to FIG. 6D are three-dimensional schematic diagrams of the multi-tactile feedback component of FIG. 1A adopting perforations and top openings of different shapes and quantities.

Referring to FIG. 1A and FIG. 6A, the top opening PH of the channel CH of the present embodiment adopts a square shape, and the perforation TH of the thin film vibration element 120 also adopts a square shape. In addition, the inner diameter of the perforation TH is greater than the inner diameter of the top opening PH.

Referring to FIG. 1A and FIG. 6B, the top opening PH of the channel CH of the present embodiment adopts a circular shape, and the perforation TH of the thin film vibration element 120 also adopts a circular shape. In addition, the inner diameter of the perforation TH is greater than the inner diameter of the top opening PH.

Referring to FIG. 1A and FIG. 6C, the top opening PH of the channel CH of the present embodiment adopts a circular array, that is, a plurality of circular openings are arranged side by side, and the perforation TH of the thin film vibration element 120 also adopts a circular array, that is, a plurality of circular openings are arranged side by side. In addition, the inner diameter of the perforation TH is greater than the inner diameter of the top opening PH.

Referring to FIG. 1A and FIG. 6D, the top opening PH of the channel CH of the present embodiment adopts a square array, that is, a plurality of square openings are arranged side by side, and the perforation TH of the thin film vibration element 120 also adopts a square array, that is, a plurality of square openings are arranged side by side. In addition, the inner diameter of the perforation TH is greater than the inner diameter of the top opening PH.

In addition, the top opening PH of the channel CH adopts a single round hole or square hole, depending on the needs. When the top opening PH of the channel CH adopts an array of round holes or an array of square holes, the resolution of the thin film deformation element 110 may be improved and the deformation feedback of the thin film deformation element 110 may be optimized.

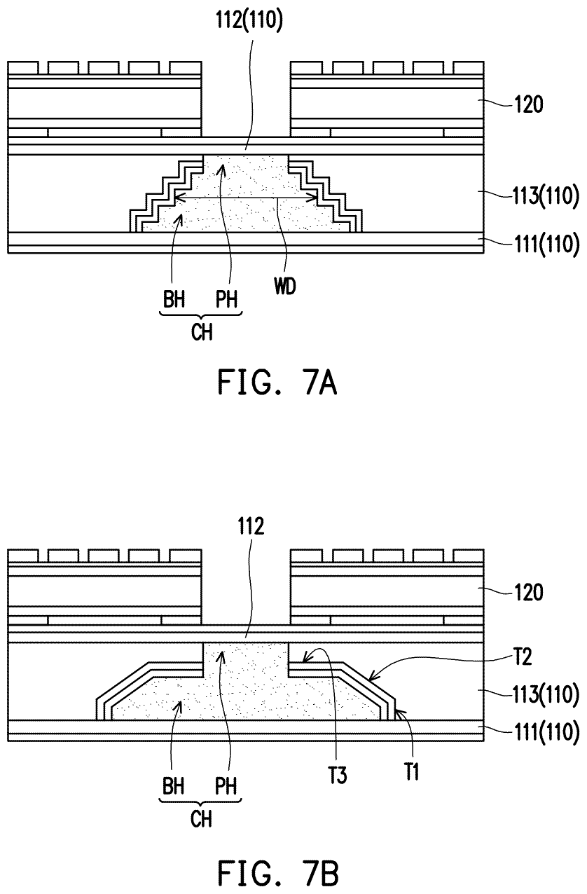

FIG. 7A and FIG. 7B are three-dimensional schematic diagrams of the multi-tactile feedback component of FIG. 1A adopting channels of different shapes.

Referring to FIG. 7A, the channel CH of the gain layer 113 of the present embodiment has a bottom opening BH and a top opening PH, the width WD of the bottom opening BH is gradually decreased from the first elastic layer 111 toward the second elastic layer 112 to form a funnel-shaped appearance, and the inner side of the bottom opening BH presents a stepped surface, the top opening PH is connected to the bottom opening BH and partially exposes the second elastic layer 112, and the width WD of the top opening PH is fixed and constant. Furthermore, since the electrostatic force is inversely proportional to the spacing, the stepped surface adopted in the present embodiment may reduce the driving voltage of the thin film deformation element.

Referring to FIG. 7B, the channel CH of the gain layer 113 of the present embodiment has a bottom opening BH and a top opening PH, and the width WD of the bottom opening BH is gradually decreased from the first elastic layer 111 toward the second elastic layer 112 to form a funnel-shaped appearance. Specifically, the inner side of the bottom opening BH has a vertical surface T1, an inclined surface T2, and a horizontal surface T3. The vertical surface T1 is orthogonal to the first elastic layer 111. The inclined surface T2 is extended from the top of the vertical surface T1. The horizontal surface T3 is extended from the top of the inclined surface T2 and parallel to the first elastic layer 111. The top opening PH is connected to the bottom opening BH and partially exposes the second elastic layer 112. The width of the top opening PH is fixed and constant. Furthermore, the rear position of the thin film deformation element of the present embodiment may keep the spacing between the two electrodes very small. The closer the two electrodes are, the greater the electrostatic force that may be provided.

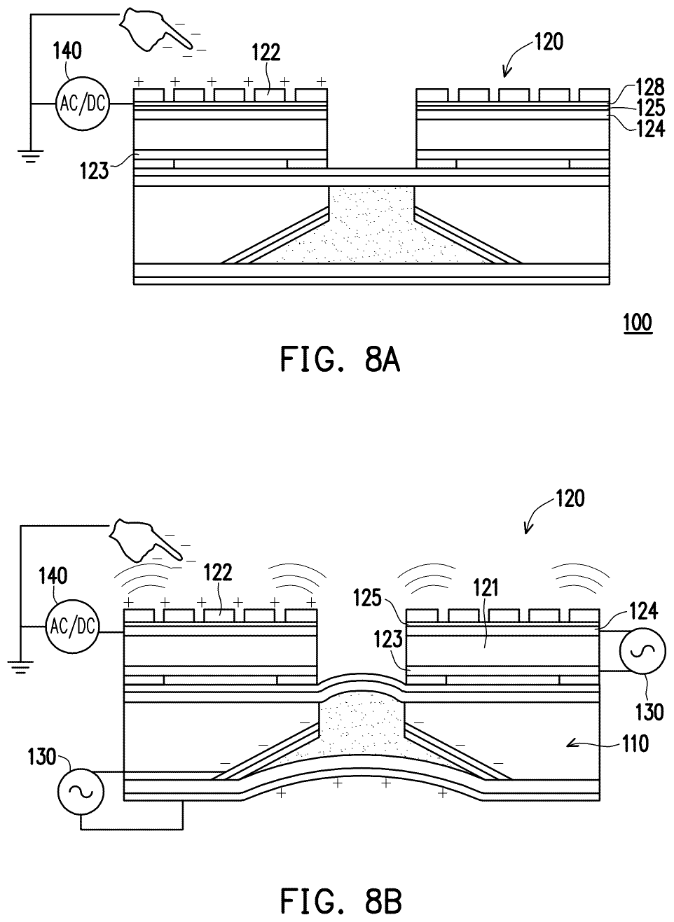

FIG. 8A is a schematic structural diagram of the multi-tactile feedback component of FIG. 1A combined with an external power supply.

Referring to FIG. 8A, the multi-tactile feedback component 100 further includes an external power supply 140. The external power supply 140 is coupled to the fifth metal layer 128 of the thin film vibration element 120. The fifth metal layer 128 is located between the barrier layer 125 and the tactile structures 122. The external power supply 140 is coupled to the fifth metal layer 128. When the external power supply 140 supplies power to the fifth metal layer 128, the plurality of tactile structures 122 generate positive charge, thereby allowing the plurality of tactile structures 122 to achieve a tactile sensation of electrostatic friction.

FIG. 8B is a schematic structural diagram of the common electrode of the external power supply and the power module of FIG. 8A.

Referring to FIG. 8B, the external power supply 140 and the power module 130 of the present embodiment share a common electrode (the fourth metal layer 124), that is, the two form one loop. When the external power supply 140 supplies power to the third metal layer 123 and the fourth metal layer 124, the plurality of tactile structures 122 generate positive charge, such that the plurality of tactile structures 122 achieve the tactile sensation of electrostatic friction. The external power supply 140 also supplies power to the thin film vibration element 120 such that the piezoelectric layer 121 is suitable for vibrating synchronously. Therefore, the thin film vibration element 120 has multi-tactile sensations simultaneously generating electrostatic friction and periodic vibration.

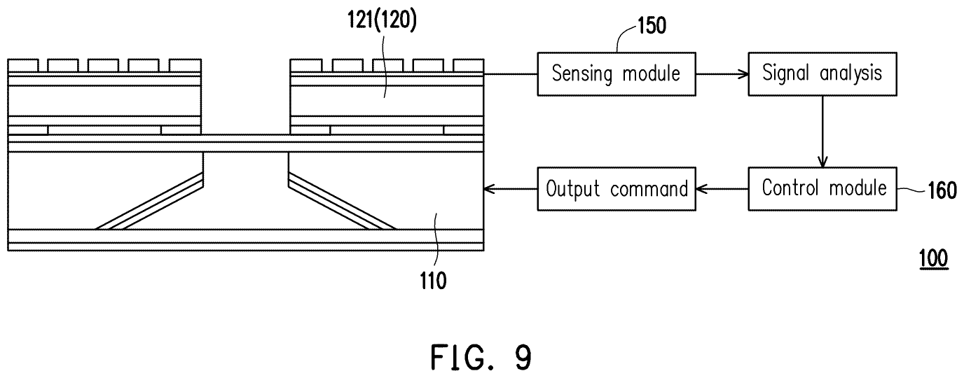

FIG. 9 is a schematic structural diagram of the multi-tactile feedback component of FIG. 1A combined with a sensing module and a control module.

Referring to FIG. 1A and FIG. 9, the multi-tactile feedback component 100 further includes a sensing module 150 and a control module 160. The sensing module 150 is coupled to the thin film vibration element 120, and the control module 160 is coupled to the sensing module 150 and the thin film deformation element 110. The sensing module 150 (such as a pressure gauge) is adapted to detect the external force of the thin film vibration element 120 and transmit a command via the control module 160 to provide power to the thin film deformation element 110 to deform the thin film deformation element 110.

Specifically, the piezoelectric layer 121 of the thin film vibration element 120 may utilize the inverse piezoelectric effect to convert the deformation of the piezoelectric layer 121 into an electrical signal, then transmit the electrical signal to the sensing module 150. Whether an external force is applied to the thin film vibration element 120 is analyzed via the sensing module 150. If yes, the first signal is transmitted, and if not, the second signal is transmitted. After the first signal or the second signal is transmitted to the control module 160, the control module 160 locks the corresponding command according to the first signal or the second signal to activate the thin film deformation element 110 or the thin film vibration element 120, so as to generate multi-tactile sensations such as deformation feedback, vibration feedback, or both.

The above applies to the user's own active control of the multi-tactile feedback component 100.

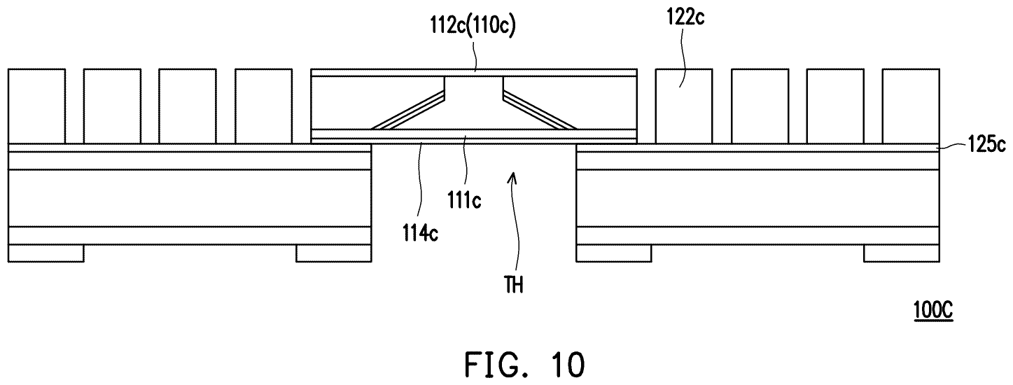

FIG. 10 is a schematic structural diagram of a multi-tactile feedback component of another embodiment of the disclosure.

Referring to FIG. 10, a multi-tactile feedback component 100C of the present embodiment is different from the multi-tactile feedback component 100 shown in FIG. 1A. The difference is that, the perforation TH of a thin film vibration element 120c is formed at the center of the thin film vibration element 120c, a first elastic layer 111c of a thin film deformation element 110c is disposed at a barrier layer 125c of the thin film vibration element 120c, and the first elastic layer 111c and a first metal layer 114c cover the perforation TH, and a plurality of tactile structures 122c surround the thin film deformation element 110c on the outside and are flush with the second elastic layer 112c.

Furthermore, the planar size of the thin film deformation element 110c of the present embodiment is smaller than that of the lower thin film vibration element 120c, allowing the plurality of tactile structures 122c to be extended upward to facilitate the user's touch.

Based on the above, the multi-tactile feedback component according to an embodiment of the disclosure is suitable for wearable electronic products, smart devices, touch screens, VR devices, medical assistance machines, hospital surgical machines, professional training (situation simulation), interactive touch screens, sports equipment, entertainment devices, or other similar electronic devices. In particular, in the multi-tactile feedback component of an embodiment of the disclosure, the elements are miniaturized using a multi-layer thin film stacking process to alleviate the shortcomings of excessive volume and weight, and thin film deformation elements and thin film vibration elements are integrated using techniques such as highly-elastic deformation thin film, high-gain piezoelectric vibration structure, high-electrostatic field thin film, and array patterning. A variety of tactile sensations such as deformation feedback, vibration feedback, and friction feedback may be simultaneously generated, thereby improving the realism of the multi-tactile feedback component.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A multi-tactile feedback component, suitable for an electronic device, the multi-tactile feedback component comprising:
a thin film deformation element having a first elastic layer, a second elastic layer, and a gain layer, wherein the gain layer is disposed between the first elastic layer and the second elastic layer and forms a channel to accommodate a fluid; and
a thin film vibration element connected to the thin film deformation element and having a piezoelectric layer and a plurality of tactile structures, and the tactile structures are disposed at a side surface of the piezoelectric layer; and
a power module coupled to the thin film deformation element and the thin film vibration element,
wherein when the power module supplies an electrical energy to the thin film deformation element, the first elastic layer is deformed to push the fluid and the second elastic layer,
wherein when the power module supplies the electrical energy to the thin film vibration element, the piezoelectric layer vibrates.

2. The multi-tactile feedback component of claim 1, wherein the thin film deformation element has a first metal layer, a second metal layer, and an insulating layer, the first metal layer is disposed at the first elastic layer and away from the gain layer, the second metal layer is disposed on an inner wall surface of the gain layer facing the first elastic layer, and the insulating layer covers the second metal layer.

3. The multi-tactile feedback component of claim 1, wherein the thin film deformation element has a first metal layer, a second metal layer, a first magnetic block, and a second magnetic block, the first metal layer is disposed at the first elastic layer and away from the gain layer, the second metal layer is disposed between the gain layer and the first elastic layer, and the first metal layer and the second metal layer are partially overlapped, the first magnetic block is disposed at the second metal layer, and the second magnetic block is disposed at the second elastic layer and aligned with the first magnetic block.

4. The multi-tactile feedback component of claim 1, wherein the thin film deformation element has an insulating layer, a first metal layer, a second metal layer, and two-finger interdigitated electrodes, the insulating layer is disposed at a side of the gain layer relative to the first elastic layer, the first metal layer and the second metal layer are respectively disposed at two opposite sides of the second elastic layer, the first metal layer is in contact with the insulating layer, and the two-finger interdigitated electrodes are located in the channel and spaced apart from each other.

5. The multi-tactile feedback component of claim 1, wherein the thin film vibration element has a third metal layer, a fourth metal layer, a barrier layer, and a support layer, the third metal layer and the fourth metal layer are respectively disposed at two opposite sides of the piezoelectric layer, the barrier layer covers the fourth metal layer, the tactile structures are distributed in an array at the barrier layer, and the support layer is disposed at the third metal layer.

6. The multi-tactile feedback component of claim 5, wherein the thin film vibration element has a perforation, the tactile structures surround the perforation on an outside, the support layer is connected to the second elastic layer, and the second elastic layer partially enters the perforation after being deformed.

7. The multi-tactile feedback component of claim 5, wherein the tactile structures adopt square pillars, tower shapes, cylinders, or a combination of the above.

8. The multi-tactile feedback component of claim 5, wherein the thin film vibration element has a perforation, the first elastic layer of the thin film deformation element is disposed at the barrier layer and covers the perforation, and the tactile structures surround the thin film deformation element on an outside and are flush with the second elastic layer.

9. The multi-tactile feedback component of claim 5, wherein the support layer is disposed around an edge of the third metal layer.

10. The multi-tactile feedback component of claim 5, wherein the support layer is disposed at two opposite edges of the third metal layer.

11. The multi-touch feedback component of claim 5, further comprising an auxiliary layer disposed at a center of the third metal layer and surrounding a perforation of the thin film vibration element, wherein the support layer is disposed around an edge of the third metal layer.

12. The multi-tactile feedback component of claim 1, wherein the channel has a bottom opening and a top opening, a width of the bottom opening is gradually decreased from the first elastic layer toward the second elastic layer, the opening communicates with the bottom opening and partially exposes the second elastic layer, and a ratio of an area of the top opening to an area of the bottom opening is less than or equal to one.

13. The multi-tactile feedback component of claim 12, wherein the top opening adopts a square, a circle, a square array, or a circular array.

14. The multi-tactile feedback component of claim 5, further comprising an external power supply coupled to the fourth metal layer or a fifth metal layer of the thin film vibration element, wherein when a power is supplied to the fourth metal layer or the fifth metal layer, the tactile structures generate a positive charge.

15. The multi-tactile feedback component of claim 14, wherein the external power supply and the power module share the fourth metal layer, and the thin film vibration element is suitable for generating a positive charge and vibrating simultaneously.

16. The multi-tactile feedback component of claim 1, further comprising a sensing module and a control module, wherein the sensing module is coupled to the thin film vibration element, the control module is coupled to the sensing module and the thin film deformation element, and the sensing module is suitable for detecting an external force of the thin film vibration element and controlling the thin film deformation element to deform via the control module.

17. The multi-tactile feedback component of claim 1, wherein the fluid adopts an air, a water, a silicone oil, or a tar.

18. A thin film deformation element, suitable for an electronic device, the thin film deformation element comprising:
a first elastic layer, a second elastic layer, and a gain layer, wherein the gain layer is disposed between the first elastic layer and the second elastic layer and forms a channel to accommodate a fluid; and
a first metal layer, a second metal layer, and an insulating layer, wherein the first metal layer is disposed at the first elastic layer and away from the gain layer, the second metal layer is disposed on an inner wall surface of the gain layer facing the first elastic layer, and the insulating layer covers the second metal layer,
wherein the channel has a bottom opening and a top opening, a width of the bottom opening is gradually decreased from the first elastic layer toward the second elastic layer, the opening communicates with the bottom opening and partially exposes the second elastic layer, and a ratio of an area of the top opening to an area of the bottom opening is less than or equal to one,
wherein the first metal layer and the second metal layer are subject to an electrostatic attraction, and the first elastic layer is deformed to push the fluid and the second elastic layer.

19. The thin film deformation element of claim 18, wherein an inner side of the bottom opening presents a stepped surface.

20. The thin film deformation element of claim 18, wherein an inner side of the bottom opening has a vertical surface, an inclined surface, and a horizontal surface, the vertical surface is orthogonal to the first elastic layer, the inclined surface is extended from a top of the vertical surface, and the horizontal surface is extended from a top of the inclined surface and is parallel to the first elastic layer.
